(19) United States
(12) Patent Application Publication
(10) Pub. No.: US 2009/0060168 A1
(43) Pub. Date: Mar. 5, 2009

(54) NETWORK INTERFACE

(76) Inventors: Charles D. CORRY, Chicago, IL (US); D. Scott Grote, Sugar Grove, IL (US); Edward Eaton, Eola, IL (US); Brian W. Matthews, Waterman, IL (US)

Correspondence Address: MCGUIREWOODS, LLP, 1750 TYSONS BLVD, SUITE 1800, MCLEAN, VA, 22102, US

(21) Appl. No.: 12/201,451

(22) Filed: Aug. 29, 2008

Related U.S. Application Data
(60) Provisional application No. 60/969,405, filed on Aug. 31, 2007.

(51) Int. Cl. H04M 1/00

(52) U.S. Cl. 379/413.04

(57) ABSTRACT

A network interface device (NID) and associated printed circuit board is provided that includes metallic die cast housing and doors configured so that one of the doors, when closed, physically separates service provider circuitry from the customer premise equipment (CPE) side connections on a circuit card within the NID so that an end-customer may access the CPE side connections while the service provider circuitry remains secured from end-customer access. Moreover, the metallic housing provides increased physical strength and tamper resistance, including improved heat dissipation properties to radiate internal heat build-up more efficiently. The NID may be configured to provide insertable interface cards to permit flexibility in service provisioning and includes options for a type-200 T1 module, a type-400 T1 module, a type-200 high bit rate Digital Subscriber Line (HDSL) module, a type-400 HDSL module or an ISDN module.

### CROSS-REFERENCE TO RELATED APPLICATIONS

This non-provisional application claims benefit of U.S. Provisional Application No. 60/969,405, filed Aug. 31, 2007, entitled DIE CAST OUTDOOR NETWORK INTERFACE ASSEMBLY (ONIA) DESIGNED TO HOUSE 2 OR 4 FRONT ACCESS DS1/T1/HDSLx CONNECTORS, the disclosure of which is hereby incorporated by reference herein in its entirety.

### BACKGROUND OF THE INVENTION

1. Field of the Invention

The invention is directed generally to a network interface device and, more particularly, to a die cast outdoor network interface device that includes various configurations such as to control access by service personnel separate from a consumer and improve surface mounting.

2. Related Art

The telecommunications industries, as well as other industries, continue to expand services to customers that include a variety of digital and analog voice, data and video applications. Most notably, expansion of access to the Internet has increased line demand and associated bandwidth.

Generally, telecommunications are delivered to a customer, such as residence or a business, by any of several mediums such as, for example, a DS0/DS1 type of connection, such as traditional POTS tip and ring, T1 or Digital Subscriber Line (DSL) type of connectivity, for example. The physical connectivity from a communications service provider is typically terminated at some form of a demarcation device such as a network interface device (NID), which is a device often located external to the customer's building and wherein the communications service provider connectivity may be demarcated from the customer controlled physical plant, such as a wiring infrastructure internal to the customer's premises.

Traditional NID housings have been made from plastic or plastic-like material which provides minimal physical strength for withstanding unauthorized entry by force. Moreover, the plastic or plastic-like materials provide minimal heat conductance/dissipation capability to transfer heat out of the NID. Moreover, some traditional NIDs employ plastic type hinges which tend to fail with use.

Even though card modules have been used to implement advanced transmission protocols in high-density telecommunication environments, card modules rarely, if ever, find applications involving relatively few user lines, such as residences. Instead, each of these locations is usually provided with at least one wall-mounted box known as a remote terminal that provides an interface between the communications service provider feed line and each customer premise equipment (CPE) line. However, traditional NIDs typically do not permit front access to modules within the NID. Some even require a “door within a door” approach to gain access to modules within the NID. This approach is inconvenient for installers, and the extra door is another point of failure. Further, traditional NIDs often employ a significant number of electrical connectors and/or flex cables to connect multiple internal electrical circuit boards, which are extra points of failure.

Increase in bandwidth demands and/or newer demanded technologies by consumers, at residences and businesses, also gives impetus for better demarcation devices such as a NID for providing better interfacing techniques and flexibility to handle a wider variety of technologies at the demarcation devices, without a need to replace an entire interface device.

Accordingly, a need exists for increasing flexibility of a network demarcation device while improving overall flexibility and increased access security for the communications service provider and consumer.

### SUMMARY OF THE INVENTION

The invention meets the foregoing need and overcomes the short-comings of the prior art. The invention includes providing for a more durable and flexible network interface device that also permits an end-customer to access customer premise equipment interfaces while denying access to service provider interface circuitry.

In one aspect, a network interface device (NID) is provided that includes a compartment constructed to house a printed circuit board (PCB) that includes service provider interfacing circuitry and customer premise equipment (CPE) interfacing circuitry and a pair of doors, wherein a first door of the pair of doors is rotatably mounted on a first side of the compartment opposite a second side of the compartment to which a second door of the pair of doors is rotatably mounted, wherein a portion of the first door of the pair of doors is configured to create a barrier between the service provider circuitry and the CPE interfacing circuitry when the first door is in a closed position.

In another aspect, a network interface device is provided that includes a printed circuit board (PCB) comprising service provider interfacing circuitry and customer premise equipment (CPE) interfacing circuitry, an enclosable die-cast metallic housing for mounting the single printed circuit board therein, and means for protecting the service provider interfacing circuitry from access while the customer premise equipment (CPE) interfacing circuitry is being accessed.

In yet another aspect, a network interface printed circuit board (PCB) mounted in a network interface device having a housing and a pair of doors rotatably mounted to opposing sides of the housing is provided that includes service provider interfacing circuitry and customer premise equipment (CPE) interfacing circuitry, wherein the service provider interfacing circuitry is configured to be located substantially separate from the customer premise equipment (CPE) interfacing circuitry so that at least a portion of a first door of the pair of doors is configured to physically separate the service provider interfacing circuitry from the customer premise equipment (CPE) interfacing circuitry while a second door of the pair of doors is in an open position.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a perspective view of a closed network interface device (NID), constructed according to principles of the invention;

FIG. 2A is a front view, FIG. 2B is a right elevation view, FIG. 2C is a bottom view and FIG. 2D is a perspective rear view of the closed NID of FIG. 1;

FIG. 3 is a perspective of a partially opened NID of FIGS. 1-2D;

FIG. 4A is a perspective view of the NID of FIGS. 1-3, with the left door and right door in an open position;

FIG. 4B is a top view and FIG. 4C is a bottom view of the NID of FIG. 4A;

FIG. 5A is a functional block diagram of an embodiment of the circuit board of FIG. 4A;

FIG. 5B is a functional block diagram of another embodiment of the circuit board of FIG. 4A;

FIG. 6A is a perspective illustration of an embodiment of a mounting bracket, constructed according to principles of the invention;

FIG. 6B is another perspective view of the mounting bracket of FIG. 6A;

FIG. 6C is a left elevation view, FIG. 6D is a top view and FIG. 6E is a right elevation view showing an embodiment of a bracket assembled with the mountable base of the NID of FIG. 1;

FIG. 7 is an exemplary schematic drawing substantially of the circuit boards of FIGS. 5A and 5B; and

FIG. 8 is an illustration of an example of a sun reflector constructed to fit over a portion of the NID of FIG. 1.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with references to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

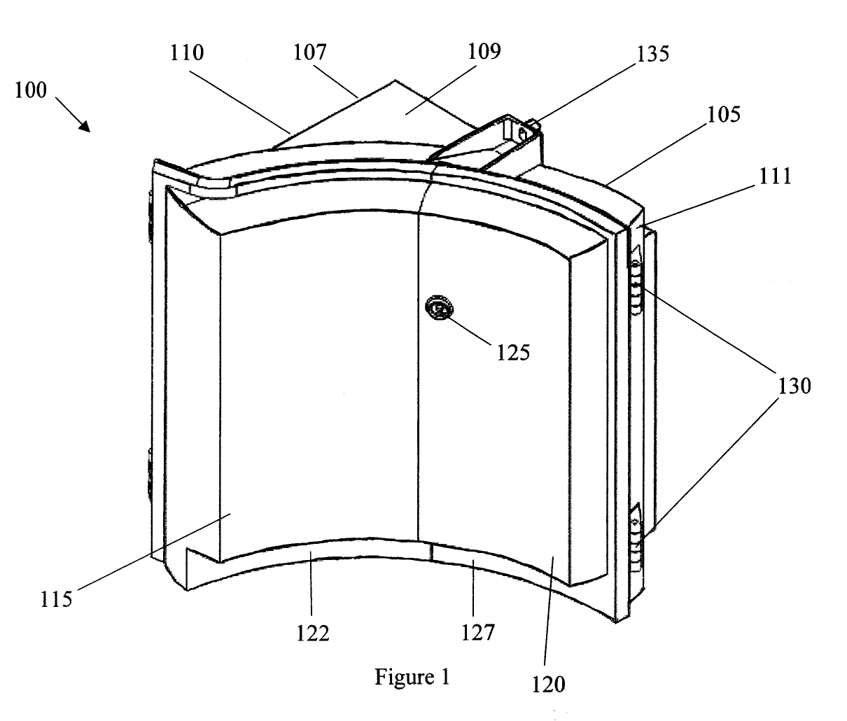

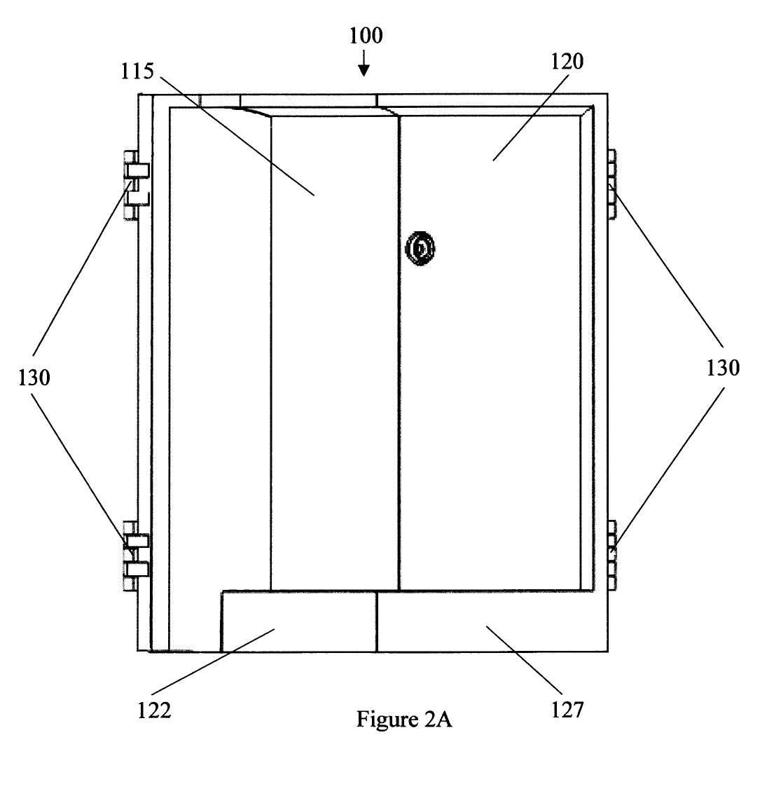

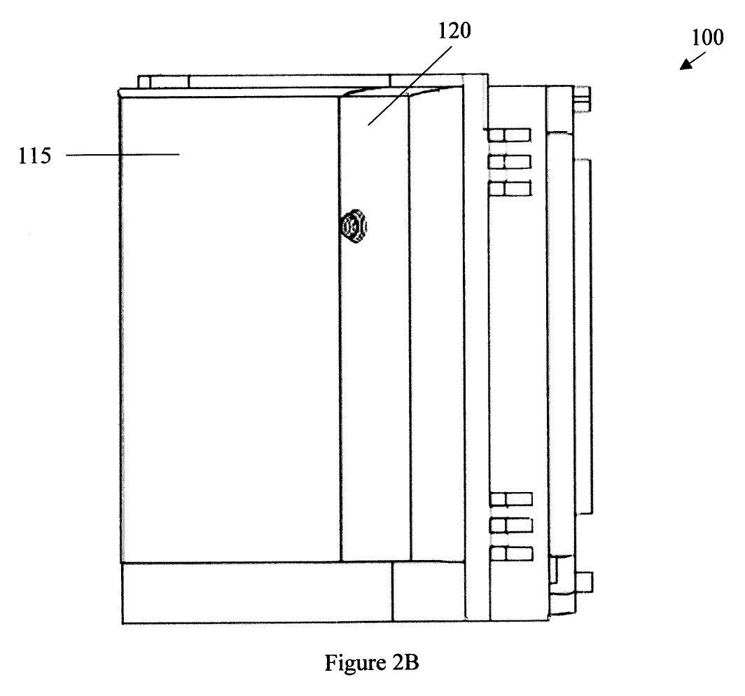

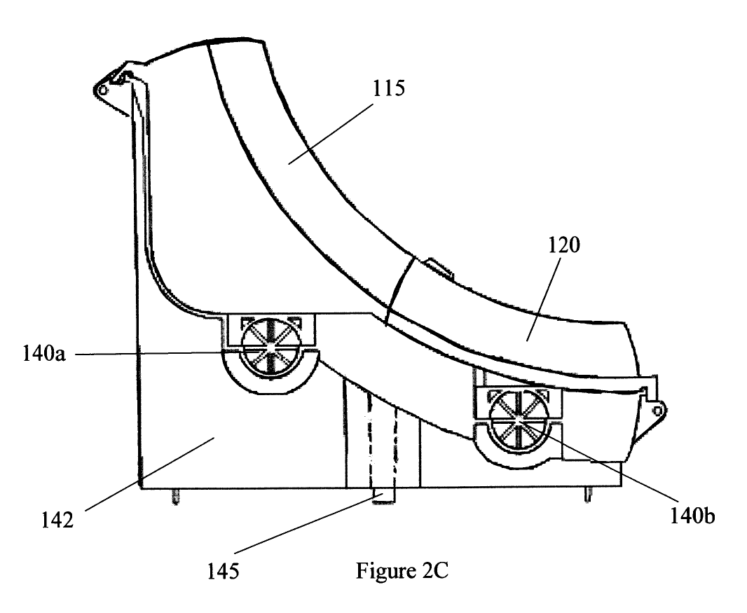

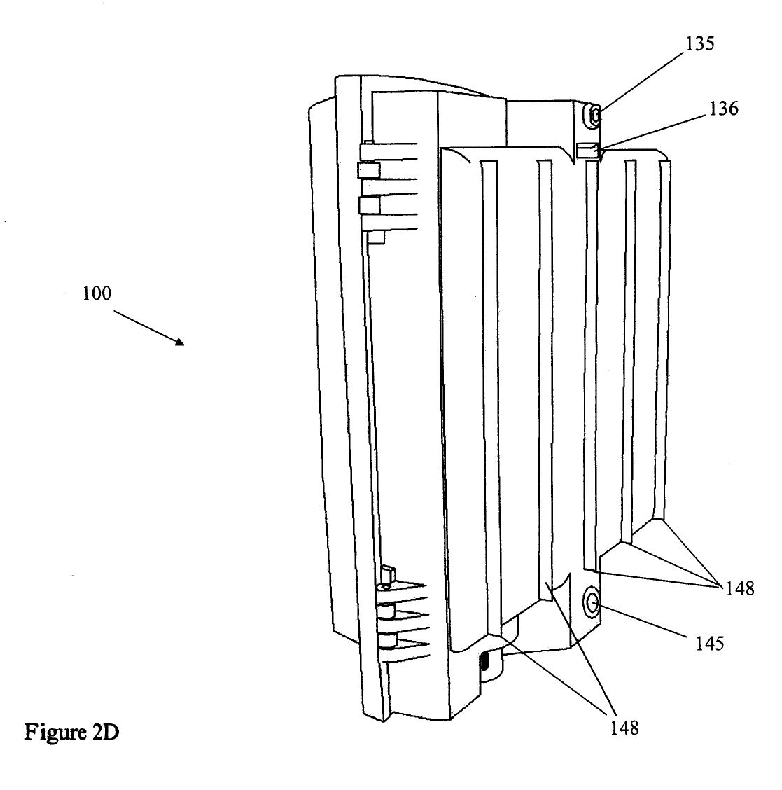

FIG. 1 is a perspective view of a closed network interface device (NID), constructed according to principles of the invention, generally designated by reference numeral 100. FIG. 2A is a front view, FIG. 2B is a right elevation view, FIG. 2C is a bottom view and FIG. 2D is a perspective rear view of the closed NID of FIG. 1. The NID 100 may be constructed by die-casting using aluminum, an aluminum based alloy or similar metallic material. The use of metallic material to construct the NID 100 may provide greatly increased physical durability and increased security providing improved tamper resistance. Moreover, the metallic properties aid in thermal dissipation of heat and thermal loading. The dissipation properties of the die cast metallic materials lower temperatures in the operational NID 100, typically placed outdoors, but could be placed indoors in some applications. The configuration of the NID 100 also may provide a pleasing cosmetic appearance and permit front access to the internal modules, as described more fully below. The use of separate internal doors as found in the prior art may be avoided.

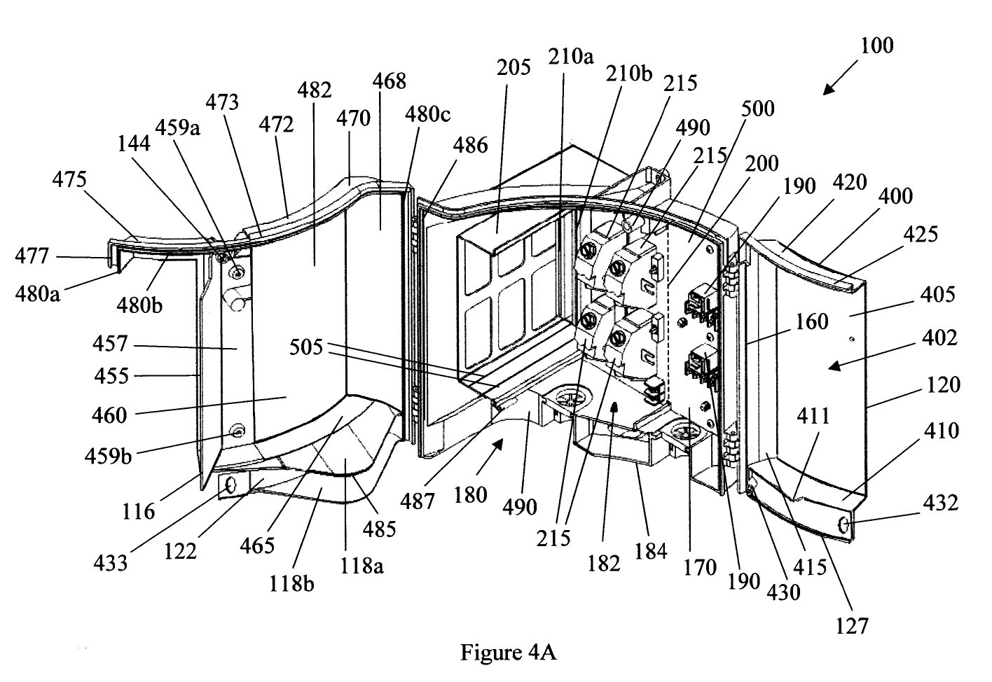

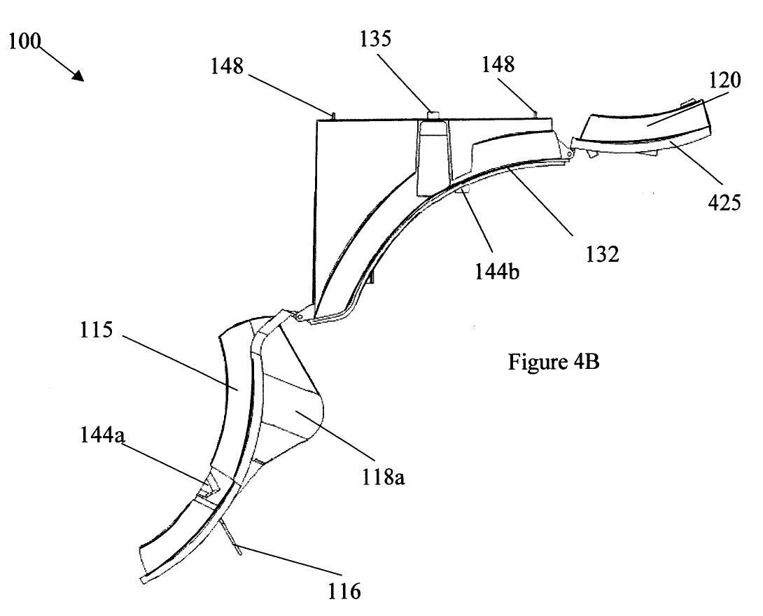

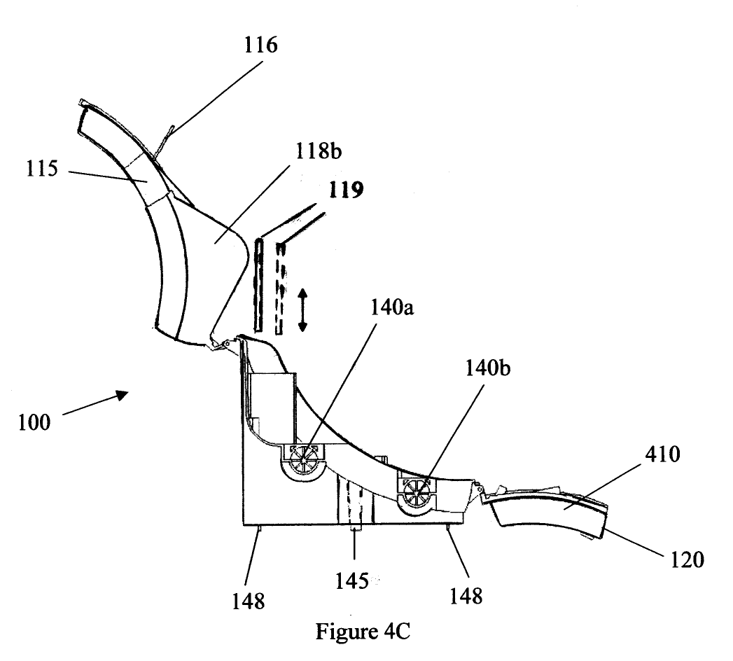

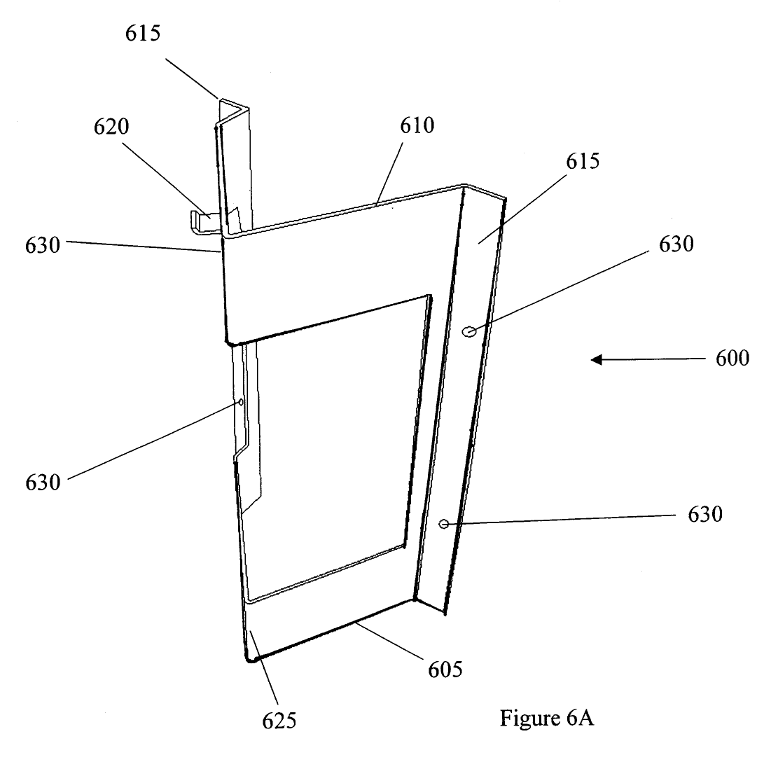

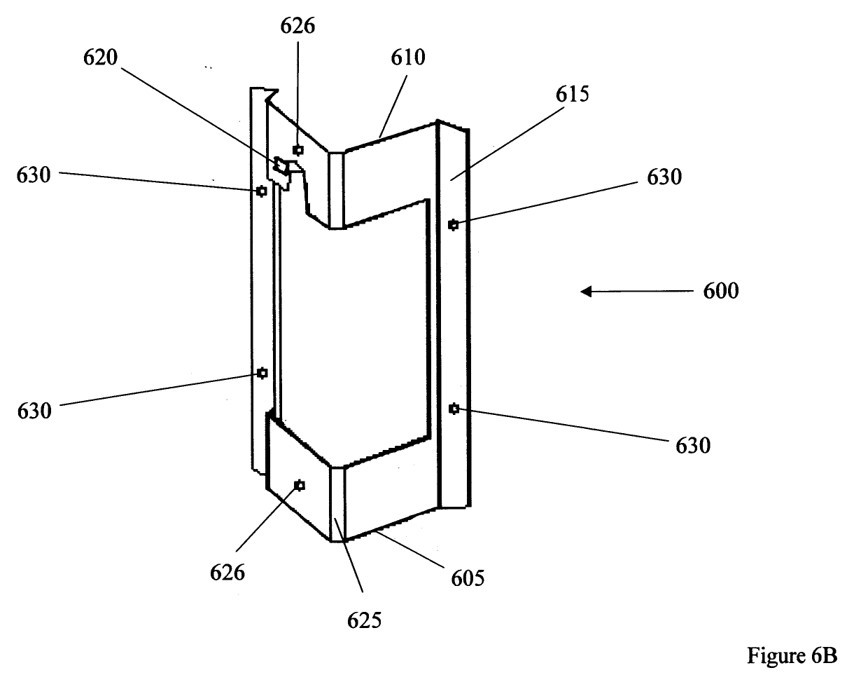

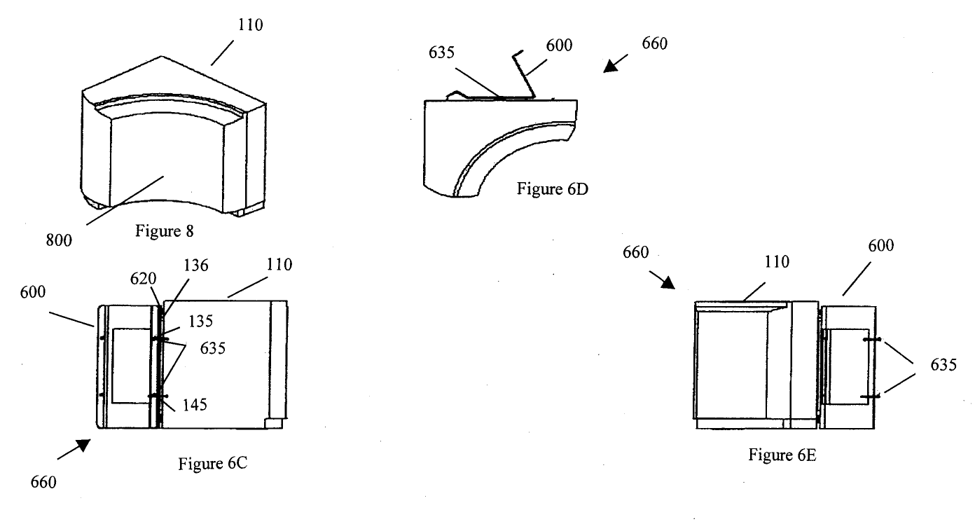

The NID 100 may include a mountable base 110 forming a compartment to house circuitry therein and may include a first generally flat side 105 having an outer and inner surface for holding at least one circuit board 500 (FIG. 4A), and for mounting the NID 100 to a wall (not shown) directly, or to receive a mounting bracket (e.g., 600, FIG. 6) also for mounting the NID 100 to a wall or other structure, as described more fully below. The NID 100 may be mounted to a wall or other structure using mounting mechanisms 135, 145, typically also using a bolt, screw, hex and pin type fastening mechanism, or the like.

The mountable base 110 further may include opposing second and third generally flat sides, each having an inner and outer surface; the opposing sides are designated as reference numerals 107 and 111, respectively. The second and third generally flat sides 107, 111 are each configured at approximately a right angle with the first generally flat side 105. The mountable base 110 further may include a top side 109 and a bottom side 142 (see FIG. 2C) opposing one another, with each having an inner and outer surface. The top side 109 and the bottom side 142 each may join with the first generally flat side 105, the second generally flat side 107, and the third generally flat side 111 to form a compartment 180 (FIG. 4A) of the mountable base 110 to house circuitry therein.

The top side 109 and the bottom side 142 each may have a surface area proximate the second generally flat side 107 greater than the surface area proximate the third generally flat side 111. This surface area dimensionality may be a result of the width of the second side 107 being constructed wider than the width of the third side 111, the width of each side 107, 111 being measured perpendicular from the first generally flat side 105. The width of the second side 107 may be more than twice the width of the third side 111. Moreover, a front edge 132 (FIG. 4B) of the top side 109 may form a concave radius connecting an edge of the second generally flat side 107 furthermost from the first generally flat side 105 to an edge of the third generally flat side 111 furthermost from the first generally flat side 105. The front edge 132 may be configured to be mateable with rotatable doors 115 and 120, described more fully below.

The NID 100 further may include a left door 115 and a right door 120. The mountable base 110 and compartment 180 may be substantially secured from environmental elements and unauthorized access by the left door 115 and the right door 120, both doors being mateable with the mountable base 110 at least along front edge 132, an outer side edge of the second generally flat side 107, and an outer edge of the third generally flat side 111. The left door 115 and the right door 120 may be attached to the mountable base 110 by at least one hinge 130 that may include a top hinge and bottom hinge for each door, thereby permitting opening and closing of each respective door. The NID 100 may be secured by a securing mechanism 125, which secures the left door 115 and the right door 120 with the mountable base 110. The securing mechanism 125 may comprise a hex and pin type fastening mechanism, a bolt, or a locking mechanism, such as a keyed lock, but could be a combination lock, for example. The outer surface of left door 115 and the outer surface of right door 120 (when the doors are viewed in a closed position) may be constructed with a radius that substantially matches the concave radius of front edge 132. The left door 115 and right door 120 may be constructed by die-casting using an aluminum based alloy, or similar metallic material. Moreover, the at hinges 130 may be die cast of similar materials as the mountable base 110, and may be enlarged somewhat to provide greater strength and better resistance to environmental and elemental exposure, as compared with typical materials employed by traditional prior art products that use plastic or plastic-like materials.

Referring now to FIG. 2C, the bottom side 142 may include a first port 140A for receiving a facility (e.g., telecommunications service, cable service, or the like) line connection, such as a DS0/DS1 connection, Integrated Services Digital Network (ISDN) connection, or the like, and a second port 140B for receiving customer side connectivity, generally for interfacing to customer premise equipment (CPE) such as telephones including plain old telephone service (POTS), switching equipment, facsimile machines, computers, modems, or the like.

The first port 140A may be located to permit cables/wiring to the service provider side 182 (FIG. 4A) of the NID 100, i.e., located behind door 115 when in the closed configuration, while the second port 140B may be located to permit cables/wiring to the customer side 170 (FIG. 4A), i.e., located behind door 120 when in the closed configuration, as described more fully in relation to FIG. 4A, below. The ports 140A and 140B may be constructed with a shroud (e.g., foam, plastic rubber-like materials, or the like) to create a barrier to the external elements when cabling/wiring is inserted through the ports 140A, 140B. Also shown in FIG. 2C is the mounting mechanism 145 for securing the NID 100 to a mounting structure, such as a wall, a mounting bracket, or the like. The mounting mechanism 145 may employ a screw or bolt for securing the NID 100 to the mounting structure, and may be accessible through a customer side 170 compartment, described more fully below.

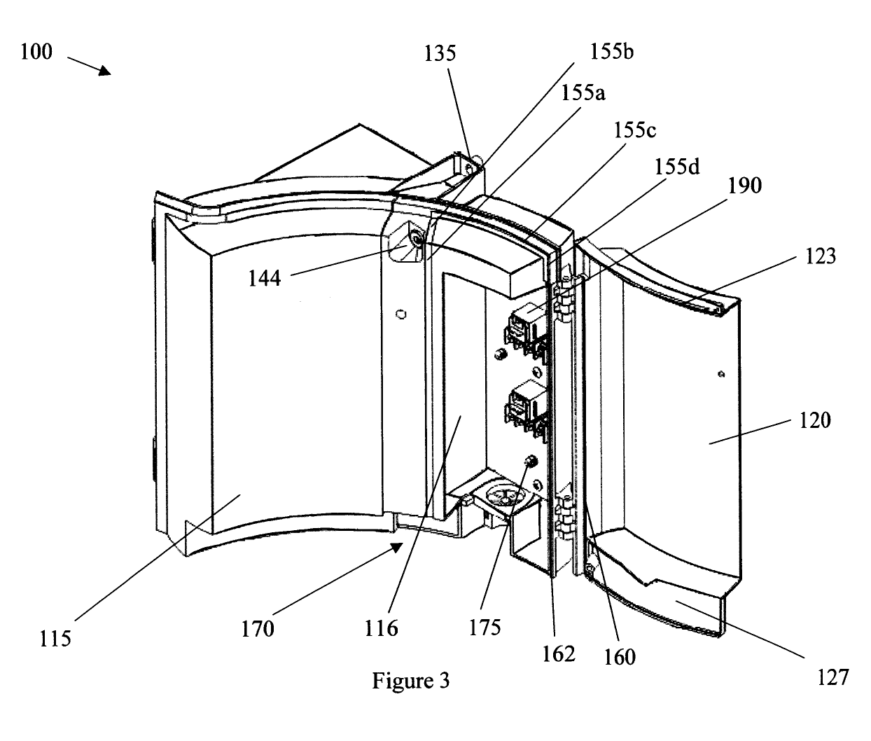

FIG. 3 is a perspective of a partially opened NID of FIGS. 1-2D. The right door 120 is shown in an open position, which permits access to the interface compartment for the customer side, generally designated by reference numeral 170. The right door 120 may include an interior cavity formed by three side walls, described more fully below in reference to FIG. 4A. A flange 127 may extend downwardly along the width of the right door 120, at the bottom of the right door 120, and may be configured with a radius that substantially matches the overall radius of the right door 120. The flange 127 may abut with the mountable base 110, when right door 120 is in the closed position. The flange 127 aids to prevent environmental materials, such as rain, dust or the like, from entering the interior of the NID 100, and may aid to secure internal components. FIG. 3 also shows that the right door 120 may be opened and closed independent of the left door 115. This configuration provides a customer access to wiring options in the interface compartment for the customer side 170, while the wiring and components of the service provider side compartment (e.g., 182 of FIG. 4A) remain securely protected behind left door 115.

The right door 120 may also be constructed with a seal 160, which might be a plastic or rubber-like seal, that may be mounted along a height of the right door 120, perhaps in a concave track that may run along the inside of the right door 120. The seal 160 may be configured to mate with a channel 162 in the third generally flat side 111, when the right door 120 is in the closed position. The seal 160 substantially prevents environmental elements (e.g., rain, snow, and/or dust) to enter the NID 100, when the doors 115, 120 are secured in respective closed positions.

The left door 115 of FIG. 3 is shown in the closed position and shows the left door 115 configured with a vertical separation portion 116 that, at least in part, may act to limit access by a customer to only the interface compartment for the customer side 170, when the right door 120 is in an open position, and preventing access to the service provider side. The vertical separation portion 116 may also include a side of the left door 115 to aid in forming a cavity of the left door 115, described more fully below in relation to FIG. 4A.

The left door 115 may be configured to include at least one seal, which may include a plastic seal, a rubber-like seal, or the like. A first seal 155a may run along an external (when right door is in an open position) vertical extent of the left door 115, a second seal 155b may run along an horizontal portion of the top of left door 115, a third seal 155c may run along a horizontal inner rim portion of the top of the left door 115, and a fourth seal 155d may run along a vertical inner rim portion of the left door 115 proximate a top hinge 130. The at least one seal 155a-155d may include separate seals, a single segment, or two, three or more segments. When the right door 120 is closed against the left door 115, the seals 155a-155d may be configured to be compressed between an outer surface of the left door 115 and an inner surface of the right door 120 to aid in preventing environmental elements from entering the NID 100. So, each door of the pair of doors 115, 120 may include at least one seal around at least part of the perimeter of each door so that the at least one seal creates a barrier to minimize environmental elements from entering the compartment when each door is closed.

FIG. 4A is a perspective view of the NID of FIGS. 1-3, with the left door and the right door in an open position. The right door 120 is shown including an inner side 405, which may have a radius, designated by reference numeral 400, a bottom side 410, a top side 420 and a vertical side 415. The top side 420, the vertical side 415, the bottom side 410 and the inner side 405 may be configured to form a four-sided cavity 402. In an aspect of the right door 120, one or more of the top side 420, the vertical side 415 and the bottom side 410 may each form a slope or non-right angle with reference to the top side 420. Moreover, the bottom side 410 and the top side 420 may be constructed with a radius on an edge adjoining the front side 402. The bottom side 410 may also include a portion 411 extending laterally in a same plane as the bottom side 410 but having a flat edge without a radius to match or mate to a flat aspect of the bottom side 142, which may include a substantially “L” shaped edge configured by the foam or rubber-like shroud material of port 140b.

The top side 420 may also include an “L” shaped lip 425 configured to mate with the third seal 155c along the horizontal inner rim portion of the top of the left door 115. The “L” shaped lip 425 may also be configured to overlap the topmost portion of the extended top portion 475 of the left door 115, when both doors 115, 120 are in a closed position. The “L” shaped lip may also extend along the vertical side 420 and may also form a channel to receive the seal 160. In some versions, a pem mount 430 may provide grounding of the NID 100. The pem mount may mate with a thread boss within the mounting base 110.

The left door 115 is shown including a front side 460 having an inner and an outer surface, which may have a radius, designated by reference numeral 472, a bottom side 465, a top side 470 and a vertical side 468. The top side 470, the vertical side 468, the bottom side 465 and the front side 460 may be configured to form a four-sided cavity 482. In an aspect of the left door 115, one or more of the top side 470, the vertical side 468 and the bottom side 465 may each form a slope or non-right angle with reference to the top side 470.

The left door 115 may be also include the vertical separation portion 116 that may include an angled portion 457 for connecting to the front side 460, such as by connecting mechanism 459a and 459b, which may include screws, rivets or bolts, for example. The vertical separation portion 116 may include a seal 455 that may be configured to contact a circuit board when the left door 115 is closed, described more fully below.

Left door 115 may also be constructed with an extended top portion 475 that may extend laterally beyond the vertical separation portion 116. A vertical overhang 477 may extend downward from the outermost portion of the extended top portion 475. The “L” shaped lip 473 may extend along the front edge of the top side 470 and extended top portion 475. The “L” shaped lip may also extend along the edge of vertical side 468. The “L” shaped lips may also form a channel for receiving one or more seals 480a, 480b, 480c, which may be a plastic, a rubber-like material or the like. The one or more seals may mate with front edge 132 and vertical edge 486 when the left door 115 (and right door) is in the closed position to prevent environmental materials out of the NID 100.

The bottom side 465 may be constructed with a first extended convex lateral portion 118a configured to mate with a respective concave portion 490 extending vertically below the bottom side 142, when the left door 115 is in the closed position. The first extended convex lateral portion 118a may include a seal 485 affixed along an edge of the extended convex portion 118a.

The left door 115 may be constructed with a flange 122 extended downwardly from the bottom side 465 of the left door 115. A second extended convex lateral portion 118b may extend laterally from the flange 122. The second extended convex flange may assist in prohibiting environmental elements from entering the NID 100.

A pem mount 487 (similar to pem mount 430) may be used to provide grounding connectivity. The pem mount 487 may be threaded to receive a screw (not shown) that may be inserted through an opening (not shown) in the flange 122 to provide grounding connectivity. The pem mounts 487 and 430 in each door 115 and 120 provide essentially 100% grounding to the NID 100, when grounded to a suitable ground perhaps by a braided ground wire. In some embodiments, a four-way ground lug may be used as part of the NID, such as described in U.S. non-provisional patent application Ser. No. 12/027,180, filed Feb. 6, 2008, entitled “FOUR-WAY GROUND LUG.”

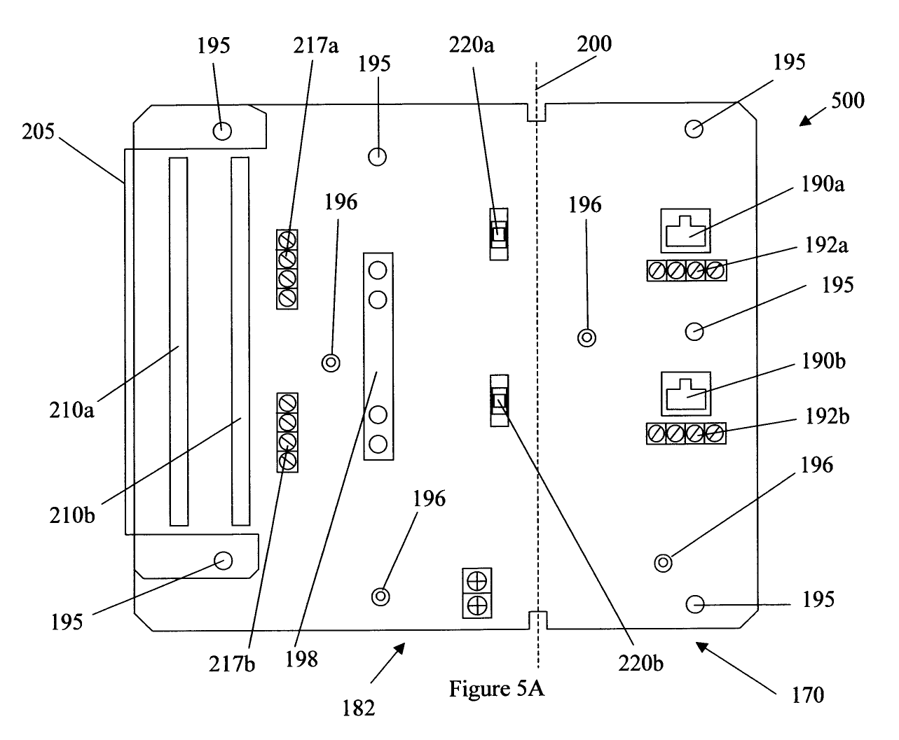

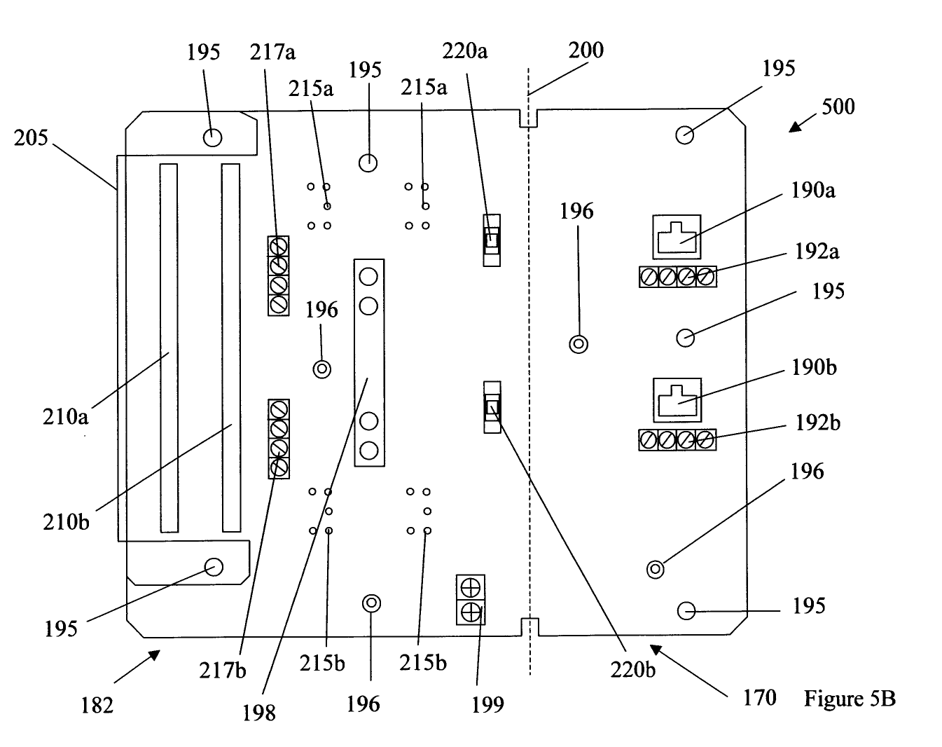

The curved designed configurations of the left door 115 and the right door 120 allows easier access to the front of the access module cage inside the NID 100, when mounted in or near a corner. In contrast, a flat door design such as found in some prior art would tend to inhibit opening the doors when such a network device may be mounted in a corner. The NID 100 may be configured to be corner mountable and configured so that the first door can be opened to gain access to at least the service provider interfacing circuitry when the NID is mounted within about three inches of a wall proximate the first side of the compartment, the access including an ability to insert of any interface card(s) into a card cage 205, described more fully below in relation to FIG. 5A.

A lower box-like compartment 184 may be configured beneath the bottom side 142 that includes the mounting mechanism 145 therein (which may be configured to receive a bolt, screw, or the like) and configured to receive a corresponding portion of the left door 115 proximate an end of the flange 122. A top edge of the box-like compartment 184 may be configured to mate with a portion of the seal 485 when the left door 115 is in a closed position.

For simplicity, FIG. 4A also shows an additional aspect not shown in the other Figures, but is not meant to be limited to the perspective of FIG. 4A. In particular, an additional mechanism to secure the left door 115 and the right door 120 may also be provided. At the bottom of the left door 115, a hole 433 may be provided in a lateral extension of the flange 122. The lateral extension may be cast as an integral part of the flange 122, or it may be a separate component that includes the hole 433, and attached to the flange 122. In the right door 120, a matching hole 432 may be provided in the flange 127. When the left door 115 and the right door 120 are in closed positions, the two holes 432, 433 align. An installer or technician may then apply another locking device using the aligned holes 432, 433. Typically, a technician or installer may employ a lead seal lock to lock the two doors 115, 120 together, however, other suitable locking devices may be employed.

Turning now to the interior of the NID 100, a circuit board 500 is shown logically partitioned by dotted vertical line 200 into the service provider side 182 and the customer side 170. The vertical line also denotes the approximate location that the seal 455 of the vertical separation portion 116 contacts the circuit board 500, when left door 115 is closed. The circuit board 500 may be a single or monolithic printed circuit board (PCB) that provides better electrical stability over time, provides higher manufacturing yields, and so on. Also, the single circuit board 500 avoids use of flex connectors. Moreover, the single or monolithic PBC approach may limit the amount of failure points. The inner surface of the first generally flat side 105 may be sufficiently flat to receive the circuit board 500, perhaps with connecting bosses or stand-offs to secure the circuit board 500 thereupon.

When the left door 115 is closed, access to only the customer side 170 of the circuit board 500 may be possible. The circuit board 500 may be configured with a card cage 205 adapted to permit one or more interface cards (119, FIG. 4C) to be inserted into one or more connectors 210a, 210b (e.g., edge connectors), perhaps guided by one or more card guide(s) 505, which aid to keep the interface card(s) securely in the one or more connectors 210a, 210b. This pluggable interface card arrangement provides electrical connectivity from the interface boards to the circuit board 500. The interface cards may be configured to provide one or more type-200 or type-400 T1, type-200 or type-400 High bit rate Digital Subscriber Line (HDSL) modules, ISDN module, for example. Other interface cards may be provided as appropriate, such as Integrated Services Digital Network (ISDN). The one or more interface cards may be front side (i.e., from the front side of the NID 100) accessible that permits installers and technicians easy access to the interface cards for quick removal or testing.

FIG. 4B is a top view and FIG. 4C is a bottom view of the NID of FIG. 4A. FIGS. 4B and 4C show stand-offs 148 that run along the outside of the first generally flat side 105. The stand-offs 148 may run substantially the entire height of the first generally flat side 105 to create channels therebetween and a space between the NID 100 and any wall to which the NID may be mounted. The channels provide a space for rain to freely escape behind the NID 100, to prevent build-up of water or moisture on the top of the NID 100 that could possibly penetrate the NID otherwise. Moreover, the channels may create an air gap with a wall to which the NID 100 may be mounted to aid in air circulation to dissipate any heat build-up from within the NID 100. The channels further may provide increased strength to the casing of the NID 100. Also shown in FIG. 4C are insertable interface cards 119, describe more fully below in reference to FIG. 5A.

A securing mechanism 144a is shown in the left door to permit a retaining device such as a hex and pin to secure or lock the left door to a respective securing mechanism 144b in the mountable base 110. Hence, the left door 115 may be locked or secured separately from the right door 120. The securing technique may be unique so that only facility personnel may gain access to the service provider side 182, perhaps by way of a specific tool, generally unavailable to the general public.

The configuration of the NID 100 permits mounting into a corner, whereas traditional network devices (e.g., found in many prior art assemblies) are not designed to be corner mounted primarily because of limitations in opening the prior art devices in a corner mounting situation. One or more aspects of the NID 100 such as, but not limited to, the dimensionality of the mounting base, various curvatures of the shape of the NID 100 and the angled back plate make accessing the interface cards (e.g., interface cards 119) and connections inside possible, while the unit is mounted in a corner (e.g., where two points of a wall come together to form about a right angle). The interior volume of the NID 100 may provide substantial air volume around the various components therein, which may aid in alleviating thermal issues.

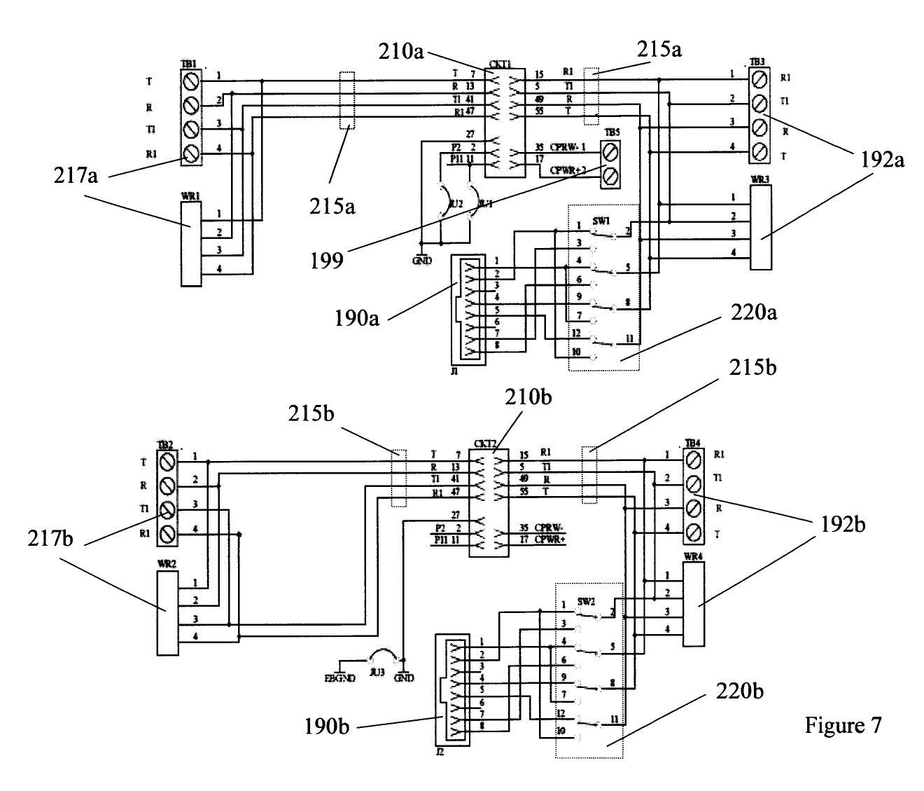

FIG. 5A is a functional block diagram of an embodiment of the circuit board of FIG. 4A, constructed according to principles of the invention. FIG. 7 is an exemplary schematic drawing substantially of the circuit boards of FIGS. 5A and 5B, and may be useful to view in conjunction with FIGS. 5A and 5B. The circuit board 500 may be a single monolithic printed circuit board (PCB) to maintain electrical stability over time, and to reduce manufacturing costs. The circuit board 500 is shown logically divided by dotted line 200 into areas. The area to the right of the dotted line 200 may be associated with customer accessible related components, i.e., the customer side 170, including customer premise equipment (CPE) interfacing circuitry. The area to the left of the dotted line 200 may be associated with facility personnel accessible components, i.e., the service provider side 182, including service provider interfacing circuitry for a communications service provider. Service provider interfacing circuitry is circuitry for the communications service provider (e.g., a telephone company, a cable company, or the like). The customer side 170 may include electrical connectivity associated with customer premise wiring and may be physically separated from the service provider side 182 by a door component (such as 116, FIG. 4A) that protects the electrical components associated with the service provider side 182 from unauthorized access when the service provider side door (e.g., door 115) is in a closed position. It should be noted that service provider personnel, such as telephone personnel, may also access the customer side 170, as necessary.

A card cage 205 for receiving circuit cards or service provider interface cards is shown connected by connections 195, which may be bolts, screws or the like, to the circuit board 500. The card cage 205 may be configured to permit one or more interface cards (119, FIG. 4C) to be inserted into one or more connectors 210a, 210b. The service provider insertable interface card(s) 119 may be configured to provide one or more type-200 or type-400 T1 or High bit rate Digital Subscriber Line (HDSL) modules, for example, or any other necessary service provider communications protocol suitable for consumer services. The insertable interface card(s) 119 may perform appropriate signal conversion for delivery of communications signals, which may include data, to the customer side 170. One or more connectors 210a, 210b may be mounted on the circuit board 500 and configured to align with one or more card guides(s) 505. The one or more connectors may each include a 56-pin edge connector. The insertable interface card(s) 119 may be inserted into the card guide(s) 505 as needed, the type of interface card may be based on customer service requirements.

Each connector 210a and 210b and its associated PCB layout may electrically mirror one another across the circuit board 500. That is, connector 210a may be electrically connected to components shown substantially in the top half of circuit board 500, generally circuit one. That is connector 210a may connect to components 215a, 217a, 220a of the service provider side 182, and to components 190a and 192a of the customer side 170. In a mirrored fashion, connector 210b may be connected to components shown substantially in the lower half of circuit board 500, generally circuit two. That is, connector 210b may be connected to components 215b, 217b, 220b of the service provider side 182, and to components 190b and 192b of the customer side 170, as described more fully below. This configuration is meant to be exemplary, as the circuit board 500 may be layed-out with other arrangements and still adhere to principles of the invention. A tie down post 175 for securing wiring may also be present on the customer side 170.

Screw terminals (alternatively, wire wrap terminals) 217a, 217b may provide for facility or service provider access connections, for circuits one and two respectively. Switch 220a may be for configuring and/or selecting the function of the customer interface jack, RJ48C/RJ48S modular jack 190a for customer access, circuit one. Switch 220b may be for configuring and/or selecting the function of the customer interface jack, RJ48C/RJ48S modular jack 190b, for customer access, circuit two. Customer interface screw terminals (alternatively, wire wrap terminals) 192a and 192b each respectively may provide for alternative customer access and wiring for circuits one and two.

Circuit card 500 may be mounted to the mountable base 110 via mounting locations 105 using appropriate connectors such as screws. Cable tie-downs anchors 196 may be provided to secure wiring to the circuit board 500 in an orderly fashion. Ground plate 198 provides grounding connectivity to the metallic mountable base 110. Terminal block 199 provide wiring points to connect and supply local power, e.g., ±48 volts d.c.

FIG. 5B is a functional block diagram of another embodiment of the circuit board of FIG. 4A, constructed according to principles of the invention. This embodiment is similar to FIG. 5A except this embodiment includes a 5-pin type lightening protection sockets 215a for both service provider side and customer side protection for circuit one, and a 5-pin type lightening protection sockets 215b for both service provider side and customer side protection for circuit two. The optional lightening protection component for the 5-pin sockets is commonly known in the industry, and the 5-pin sockets 215a, 215b may provide for in-the-field replacement of compatible lightening protection components, shown generally as components 215 (FIG. 4A). However, the lightening protection feature has not been previously employed in residential network device applications. In alternate embodiments (not shown), the circuit board 500 may comprise two or more PCBs with appropriate connections therebetween, but may decrease dependability, increase costs, and so on.

FIG. 6A is a perspective illustration of an embodiment of a mounting bracket, constructed according to principles of the invention, generally denoted by reference numeral 600. The exemplary bracket 600 may include two parallel strips of metal 615, held spaced apart from one another by two generally “V” shaped metal support members 605,610 that also may be spaced apart from one another, forming a bend 625. The bracket may be configured to allow mounting of the bracket to a wall by way of holes 630, using a fastener such as a screw, or the like. An upper generally “V” shaped support member 610 includes a “L” shaped hook 620 which is configured to insert into a mating slot 136 in the mountable base 110, just below mounting mechanism 135.

FIG. 6B is another perspective view of the mounting bracket of FIG. 6A. This perspective shows machine screw sockets 626 for use in mounting the bracket 600 to the NID 100. Sockets 626 may align with mounting mechanism 135 and mounting mechanism 145 of the mountable base 110 to securely attach the NID 100 with the bracket 600 using an appropriate bolt, hex and pin, or similar fastener.

FIG. 6C is a left elevation view, FIG. 6D is a top view and FIG. 6E is a right elevation view showing an embodiment of a bracket assembled with the mountable base of the NID of FIG. 1. The assembly 660 includes the bracket 600 secured to the mountable base 110 using a fastener 635 such as a bolt, a screw, or the like, in conjunction with mounting mechanisms 135, 145.

FIG. 7 is an exemplary schematic drawing substantially of the circuit boards of FIGS. 5A and 5B. The exemplary schematic shows substantial symmetry between circuit one (top half) and circuit two (bottom half) of the schematic. The top half also includes d.c. power terminals 199.

FIG. 8 is an illustration of an optional sun reflector constructed to fit over a portion of the NID of FIG. 1, generally designated as reference numeral 800. FIG. 8 shows the sun reflector 800 slid over a portion of the NID 100, such as the pair of doors 115, 120. The sun reflector 800 may be held in place by friction, by physical fasteners, or other similar securing techniques. The optional sun reflector 800 provides added protection from the elements, especially sunlight heat build-up. The sun reflector 800 may comprise sunlight reflecting materials. Moreover, the sun reflector 800 may provide an added cosmetic appearance to render the assembly more pleasing.

The NID 100 has been successfully tested to several industry standards and requirements including, but not limited to: GR-49, sections 3.4, 4.4, 5.1, and 5.4-5.11 and GR-63, section 4.4.1.2.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention. Moreover, any document, publication or patent referred to herein is incorporated by reference in its entirety.

What is claimed is:

1. A network interface device (NID), comprising:
a compartment constructed to house a printed circuit board (PCB) that includes service provider interfacing circuitry and customer premise equipment (CPE) interfacing circuitry; and
a pair of doors, wherein a first door of the pair of doors is rotatably mounted on a first side of the compartment opposite a second side of the compartment to which a second door of the pair of doors is rotatably mounted,
wherein a portion of the first door of the pair of doors is configured to create a barrier between the service provider circuitry and the CPE interfacing circuitry when the first door is in a closed position.

2. The network interface device of claim 1, wherein the first door when closed is configured to enclose the service provider interfacing circuitry within the compartment.

3. The network interface device of claim 1, wherein the second door of the pair of doors is configured to be opened while the first door remains closed, thereby providing access to the CPE interfacing circuitry.

4. The network interface device of claim 3, wherein the barrier is configured to prevent access to the service provider circuitry when the second door is in an open position.

5. The network interface device of claim 1, further comprising a card cage mounted within the compartment to permit at least one interface card to be inserted into the card cage while the pair of doors are in an open position.

6. The network interface device of claim 5, further comprising the PCB and wherein the card cage is mounted on the PCB and further comprises at least one connector mounted on the PCB to receive at least one inserted interface card thereby providing electrical connectivity between at least one inserted interface board and the PCB.

7. The network interface device of claim 1, further comprising the PCB.

8. The network interface device of claim 7, wherein the PCB is a single PCB.

9. The network interface device of claim 1, wherein each door is configured to be rotatably mounted by at least one hinge.

10. The network interface device of claim 9, wherein the compartment, the pair of doors and the at least one hinge each comprise a metallic die-cast material.

11. The network interface device of claim 10, wherein the metallic material comprises aluminum or an aluminum alloy.

12. The network interface of claim 1, further comprising:
the service provider interfacing circuitry, comprising:
at least one first-type connector configured to receive at least one insertable service provider interface card;
at least one second-type connector to provide connectivity to service provider service; and
at least one switch configurable to select a configuration of at least one component of the customer premise equipment (CPE) interfacing circuitry.

13. The network interface device of claim 12, wherein the service provider interfacing circuitry further comprises a terminal block to provide wiring points for local power.

14. The network interface device of claim 12, wherein the service provider interfacing circuitry further comprises at least one lightening protection device.

15. The network interface device of claim 12, wherein the at least one first-type connector comprises a plurality of first-type connectors, each configured to receive an insertable service provider interface card.

16. The network interface device of claim 15, wherein the at least one first-type connector is configured to receive an insertable service provider interface card comprising at least one of: a type-200 T1 module, a type-400 T1 module, a type-200 high bit rate Digital Subscriber Line (HDSL) module, a type-400 HDSL module and an ISDN module.

17. The network interface device of claim 12, further comprising the CPE interfacing circuitry comprising at least one CPE connector for accepting customer premise wiring.

18. The network interface device of claim 17, wherein at least one CPE connector is configured to be electrically connected to the at least one first-type connector, the at least one second-type connector and the at least one switch.

19. The network interface device of claim 18, wherein the at least one CPE connector, the at least one first-type connector, the at least one second-type connector and the at least one switch comprise a plurality of CPE connectors, a plurality of first-type connectors, a plurality of second-type connectors and a plurality of switches configured to form a plurality of distinct circuits for interfacing with a plurality of separate interface cards.

20. The network interface device of claim 1, wherein the compartment comprises:
a first generally flat side having an outer and inner surface for securing the PCB to the inner surface and for mounting the NID to a structure;
second and third generally flat sides, each having an inner and outer surface, each configured at essentially a right angle with the first generally flat side; and
a top side and a bottom side opposing one another, each having an inner and outer surface,
wherein the top side and the bottom side each join with the first generally flat side, the second generally flat side, and the third generally flat side to form the compartment.

21. The network interface device of claim 20, wherein the top side and the bottom side each have a surface area proximate the second generally flat side greater than the surface area proximate the third generally flat side.

22. The network interface device of claim 21, wherein a width of the second side is greater than a width of the third side, the width of the second side and the third side being measured perpendicular from the first generally flat side.

23. The network interface device of claim 22, wherein the width of the second side is more than twice the width of the third side.

24. The network interface device of claim 20, wherein the top side has a front edge configured to form a concave radius that connects an edge of the second generally flat side furthermost from the first generally flat side to an edge of the third generally flat side furthermost from the first generally flat side.

25. The network interface device of claim 24, wherein the front edge is configured to be mateable with the movable pair of doors.

26. The network interface device of claim 24, wherein each door of the pair of doors has an outer surface configured with a radius substantially matching the radius of the front edge.

27. The network interface device of claim 20, wherein the bottom side is constructed with a first port and a second port, the first port located behind the first door when closed and proximate the service provider interfacing circuitry, and the second port located behind a second door of the pair of doors when closed proximate the CPE interfacing circuitry, the first port configured for service provider cabling and the second port configured for CPE cabling.

28. The network interface device of claim 27, wherein each port includes a shroud comprising flexible material to inhibit entry of environmental materials into the compartment.

29. The network interface device of claim 20, wherein the outer surface of the first generally flat side includes channels extending along a vertical extent of the outer surface to space apart the compartment from a wall when mounted.

30. The network interface device of claim 29, wherein the channels provide clearance for permitting rain to run behind the compartment.

31. The network interface device of claim 1, wherein the first door is configured to be lockable separately from a second door of the pair of doors.

32. The network interface device of claim 1, wherein each door of the pair of doors includes at least one seal around at least part of the perimeter of each door so that the at least one seal creates a barrier to minimize environmental elements from entering the compartment when each door is closed.

33. The network interface device of claim 1, wherein the first door has an outer surface that includes at least one seal configured to mate against an inner portion of a second door of the pair of doors when the first door and the second door are closed thereby minimizing environmental elements from entering the compartment.

34. The network interface device of claim 1, further comprising means for grounding the compartment and the pair of doors.

35. The network interface device of claim 1, further comprising means for attaching the NID to a wall.

36. The network interface device of claim 1, further comprising a mounting bracket configured to be attached to the NID and to a structure.

37. The network interface device of claim 36, further comprising means for attaching the NID to a mounting bracket.

38. The network interface device of claim 1, further comprising a sun reflector constructed to fit over at least a front side and a top side of the NID, the sun reflector reducing heat build-up within the NID.

39. The network interface device of claim 1, wherein the NID is configured to be mounted near a wall so that the first door can be opened to gain access to at least the service provider interfacing circuitry when the NID is mounted within about three inches of the wall proximate the first side of the compartment, the access including an ability to insert one or more interface cards.

40. The network interface device of claim 1, wherein the PCB includes a card cage for slideably receiving at least one interface card to electrically connect to the PCB, wherein the card cage, compartment and the pair of doors are configured so that the at least one interface card is insertable perpendicular to the PCB while the doors are in an open position.

41. The network interface device of claim 1, further comprising means to secure the pair of doors to one another.

42. The network interface device of claim 1, further comprising means for independently securing the service provider interfacing circuitry and the customer premise equipment (CPE) interfacing circuitry.

43. A network interface device, comprising:
a printed circuit board (PCB) comprising service provider interfacing circuitry and customer premise equipment (CPE) interfacing circuitry;
an enclosable die-cast metallic housing for mounting the single printed circuit board therein; and
means for protecting the service provider interfacing circuitry from access while the customer premise equipment (CPE) interfacing circuitry is being accessed.

44. The network interface device of claim 43, wherein the PCB is a monolithic PCB that includes at least one connector for receiving at least one removable interface card for interfacing a communications service and the service provider interfacing circuitry.

45. The network interface device of claim 43, wherein the at least one removable interface card comprises at least one of: a type-200 T1 module, a type-400 T1 module, a type-200 high bit rate Digital Subscriber Line (HDSL) module, a type-400 HDSL module and an Integrated Services Digital Network (ISDN) module.

46. The network interface device of claim 43, wherein the PCB is a monolithic PCB that electrically connects the service provider interfacing circuitry and the customer premise equipment (CPE) interfacing circuitry.

47. The network interface device of claim 43, wherein the metallic housing has a top side and a bottom side and the bottom side includes a first port and a second port, the first port being proximate the service provider interfacing circuitry and the second port being proximate customer premise equipment (CPE) interfacing circuitry.

48. The network interface device of claim 47, wherein the top side has an edge configured in a concave radius mateable to a pair of doors each having a respective matching radius.

49. The network interface device of claim 47, wherein the metallic housing further has a first side and a second side, the first side configured to be larger in size than the second side, and the concave edge of the top side connecting with the first side and second side.

50. The network interface device of claim 47, wherein the pair of doors is metallic and attaches to the metallic housing by metallic hinges.

51. The network interface device of claim 43, further comprising means for mounting the network device to a structure.

52. The network interface device of claim 43, further comprising means for substantially securing the enclosable metallic housing from environmental elements.

53. The network interface device of claim 43, further comprising a sun reflector configured to be mounted at least in part over the metallic housing to reduce heat build-up within the network interface device.

54. A network interface printed circuit board (PCB) mounted in a network interface device having a housing and a pair of doors rotatably mounted to opposing sides of the housing, the PCB comprising:
service provider interfacing circuitry; and
customer premise equipment (CPE) interfacing circuitry,
wherein the service provider interfacing circuitry is configured to be located substantially separate from the customer premise equipment (CPE) interfacing circuitry so that at least a portion of a first door of the pair of doors is configured to physically separate the service provider interfacing circuitry from the customer premise equipment (CPE) interfacing circuitry while a second door of the pair of doors is in an open position.

55. The network interface printed circuit board of claim 54, wherein the service provider interfacing circuitry comprises:
at least one first-type connector configured to receive at least one insertable service provider interface card;
at least one second-type connector to provide connectivity to a service provider; and
at least one switch configurable to select a configuration of at least one component of the customer premise equipment (CPE) interfacing circuitry.

56. The network interface device of claim 55, wherein the service provider interfacing circuitry further comprises a terminal block to provide wiring points for local power.

57. The network interface device of claim 55, wherein the service provider interfacing circuitry further comprises at least one lightening protection device.

58. The network interface device of claim 55, wherein the at least one first-type connector comprises a plurality of first-type connectors, each configured to receive an insertable service provider interface card.

59. The network interface device of claim 55, wherein the at least one first-type connector is configured to receive an insertable service provider interface card comprising at least any one of: a type-200 T1 module, a type-400 T1 module, a type-200 high bit rate Digital Subscriber Line (HDSL) module, a type-400 HDSL module, and an ISDN module.

60. The network interface device of claim 55, wherein the CPE interfacing circuitry comprises at least one CPE connector configured to accept customer premise wiring.

61. The network interface device of claim 60, wherein at least one CPE connector is electrically connected to the at least one first-type connector, the at least one second-type connector and the at least one switch.

62. The network interface device of claim 60, wherein the at least one CPE connector, the at least one first-type connector, the at least one second-type connector and the at least one switch are a plurality of CPE connectors, a plurality of first-type connectors, a plurality of second-type connectors and a plurality of switches configured to form a plurality of distinct circuits for interfacing with a plurality of separate interface cards.
